(19) United States
(12) Patent Application Publication
(10) Pub. No.: US 2006/0227824 A1
(43) Pub. Date: Oct. 12, 2006

(54) Spectral conditioning mechanism

(76) Inventors: Peter J. Dyer, Nepean On Canada (CA); David A. Fisher, Kanata On Canada (CA); Peter Selwyn, Lanark On Canada (CA)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/092,021

(22) Filed: Mar. 29, 2005

(51) Int. Cl. H01S 3/13

(52) U.S. Cl. 372/29.011

(57) ABSTRACT

An optical assembly is disclosed. The optical assembly includes a laser having a front facet and a rear facet a thin film filter (TFF) to receive a first optical signal from the front facet of the laser and to reflect a component of the first optical signal back to the laser a back facet monitor (BFM) to receive a second optical signal and the reflected component from the rear facet of the laser and a feedback circuit to monitor the quantity of reflected component.

### FIELD OF THE INVENTION

The present invention relates to fiber optic communications; more particularly, the present invention relates to spectrally conditioning the output of fiber optic signals.

### BACKGROUND

More frequently, optical input/output (I/O) is being used in network elements and/or computer systems to transmit data between system components. Optical I/O is able to attain higher system bandwidth with lower electromagnetic interference than conventional I/O methods. In order to implement optical I/O, radiant energy is coupled to a fiber optic waveguide from an optoelectronic integrated circuit (IC).

Typically, a fiber optic communication link includes a transmitting device such as a laser, a fiber optic cable (or waveguide), and a light receiving element. Fiber optic transmitters and receivers are typically quite extensive. As such, there is a desire to be able to increase the span length, e.g., increase the distance between network end points. However, the adverse effects of noise, attenuation and dispersion limit the distance between network elements.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates one embodiment of a computer system;

FIG. 2 illustrates one embodiment of an optical assembly;

FIG. 3 is a graph illustrating one embodiment of a response of a back facet monitor; and

FIG. 4 is a graph illustrating another embodiment of a response of a back facet monitor.

### DETAILED DESCRIPTION

According to one embodiment, an optical sub-assembly spectral conditioning system is disclosed. The system monitors internally reflected light that does not pass thru a thin film filter (TFF), and compares the reflected light with light received at a back facet monitor (BFM). This light is used to align the emission wavelength with the TFF profile by raising or lowering the temperature of a thermo-electric cooler (TEC) when above or below a ratio identified for wavelength grid compliance.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

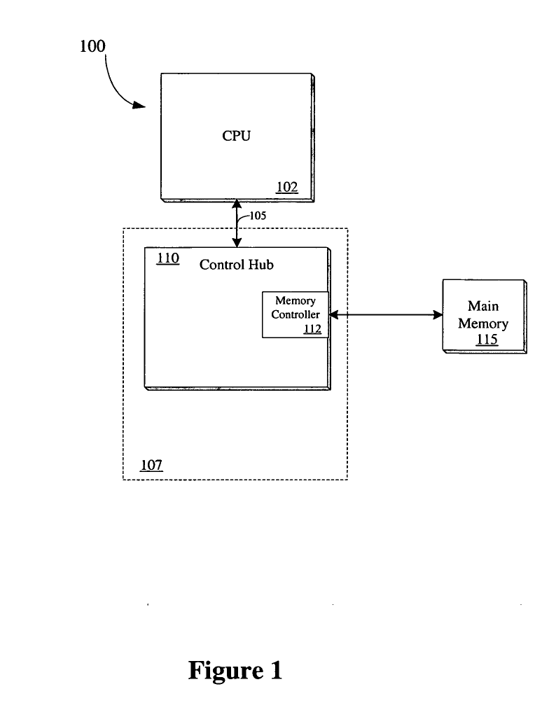

FIG. 1 is a block diagram of one embodiment of a computer system 100. Computer system 100 includes a central processing unit (CPU) 102 coupled to an interface 105. In one embodiment, CPU 102 is a processor in the Pentium® family of processors including the Pentium® IV processors available from Intel Corporation of Santa Clara, Calif. Alternatively, other CPUs may be used. In a further embodiment, CPU 102 may include multiple processor cores.

According to one embodiment, interface 105 is a front side bus (FSB) that communicates with a control hub 110 component of a chipset 107. Control hub 110 includes a memory controller 112 that is coupled to a main system memory 115. Main system memory 115 stores data and sequences of instructions and code represented by data signals that may be executed by CPU 102 or any other device included in system 100.

In one embodiment, main system memory 115 includes dynamic random access memory (DRAM); however, main system memory 115 may be implemented using other memory types. According to one embodiment, control hub 110 also provides an interface to input/output (I/O) devices within computer system 100.

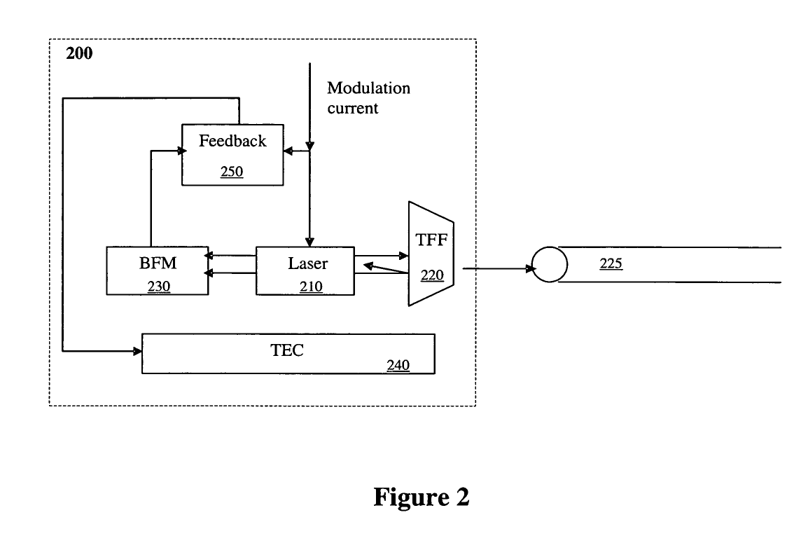

FIG. 2 illustrates of one embodiment of an optical assembly 200. In one embodiment, the optical assembly 200 is implemented to couple optical I/O between components within computer system 100. For instance, optical assembly 200 may couple optical I/O between CPU 102 and control hub 110, and/or control hub 110 and main memory 115. In other embodiments, optical assembly 200 may couple a component within computer system 100 to another computer system.

Referring to FIG. 2, optical assembly 200 includes a laser 210, thin film filter (TFF) 220, back facet monitor (BFM) 230, thermo-electric cooler 240 and feedback circuit 250. Laser 210 is directly modulated with a Non-Return to Zero (NRZ) format signal. In one embodiment, laser 210 is a Distributed FeedBack (DFB) laser. Thus, laser 210 has a front facet and rear facet to emit light.

The front facet has TFF 220 that transmits light to an optical fiber 225 for transmission of the optical signal downstream to a receiver at another system. According to one embodiment, the transmittance and reflectance of TFF 220 is wavelength dependant. Any light not transmitted by TFF 220 is reflected back into laser 210

The rear facet of laser 210 couples light, which is a fixed fraction of the light emitted by the front facet, to BFM 230. BFM 230 is a diode that provides a current output related to a quantity of light that exits the rear facet of laser 210. TEC 240 is thermally coupled to laser 210. TEC 240 is implemented to control and adjust the temperature of laser 210 in order to control the light wavelength emitted by laser 210.

Feedback circuit 250 is coupled to BFM 230 and TEC 240. According to one embodiment, feedback circuit monitors the quantity of light reflected from TFF 220. Particularly, feedback circuit 250 compares a ratio of light/current (l/i) efficiency received from BFM 230 to the modulation current transmitted to laser 210.

An output signal is transmitted to TEC 240 depending upon whether the result of the comparison at feedback circuit 250 is above or below the efficiency ratio calculation. In response, the temperature for TEC 240 is adjusted. In one embodiment, feedback circuit 250 is an analog comparator. However, feedback circuit 250 may be implemented using other methods. For instance, feedback circuit 250 may be a lookup table in firmware (e.g., ROM or FLASH memory) within computer system 100.

In one embodiment, the efficiency ratio is derived such that the quantity of light received at BFM 230 is compared with the quantity of current received at laser 210 that produces that light. In such an embodiment, TFF 220 will reflect light back into laser 210 at wavelength specific ratios. These ratios are fixed to a specific wavelength when constructing laser 210 and TFF 220. According to a further embodiment, if the calculated ratio indicates that a higher quantity of light than normal considering the current transmitted to laser 210, an excess quantity of light has been reflected from TFF 220. An output signal is transmitted to TEC 240 to adjust the temperature accordingly.

Laser 210 is temperature sensitive, and therefore, will change its wavelength of emission with a predictable characteristic over temperature. TFF 220, however, is athermal. Therefore, laser 210 can be temperature tuned to emit the wavelength critical to TFF 220. As discussed above, the ratio of light/current (l/i) efficiency is compared to the modulation current to determine the required temperature for TEC 240.

The wavelength emitted by assembly 200 can be controlled at an optimum wavelength by tuning the TEC 240 current to a point that produces the correct laser 210 efficiency for the current causing the current. This is an inflexion point in the light power versus temperature curve. Accordingly, this temperature should be the wavelength at which TFF 220 begins to restrict the transmission of light. Any light that is not transmitted is reflected back into laser 210.

The filter function of TFF 220 causes a reduced width of the spectral emission that is coupled to optical fiber 225. Thus, by creating a stable TEC 240 set point, the wavelength of the emission is locked to a TFF 220 knee that can be controlled (or built) to reside at a temperature which produces laser 210 emissions within a frequency grid specified for Dense Wavelength Division Multiplexing (DWDM) transmission.

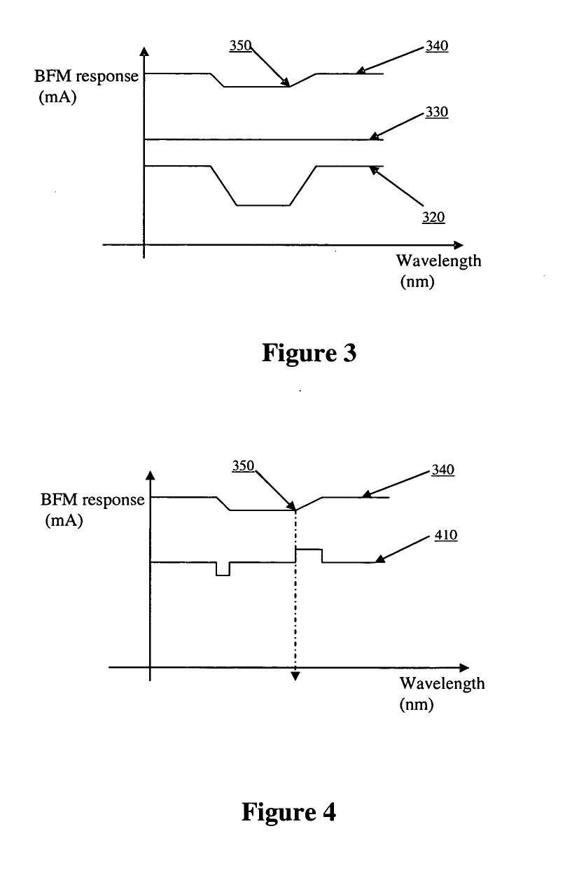

FIG. 3 is a graph illustrating one embodiment of a response of BFM 230 as laser 210 is varied over the wavelength range around the pass band of TTF 220. The contribution of the signal back-facet (330) does not vary over wavelength. The contribution due to the wavelength varying reflectance (320) of the TFF 220 shows a reflected contribution to the BFM 230 signal that diminishes in the pass band of TFF 220. The comparison of the variation in BFM 230 response and the constant modulation current level (340) provide a ratio that can be kept constant by sending any error signal to TEC 240 to keep the ratio “locked” to the edge of the filter response (350).

FIG. 4 is a graph illustrating another embodiment of a response of BFM 230 as laser 210 is varied over the wavelength range around the pass band of TTF 220. This figure shows a derivative of the BFM 230 combined response (410).

The above-described spectral conditioning system applies properties of TFF filters to a method of limiting spectral emissions from a low cost laser by monitoring internally reflected light that does not pass thru the TFF, and comparing the light with a BFM. This light is then used to align the emission wavelength with the TFF filter profile by raising or lowering the temperature of the TEC when above or below the ratio identified for ITU wavelength grid compliance.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

What is claimed is:

1. An optical assembly comprising:
a laser having a front facet and a rear facet;
a thin film filter (TFF) to receive a first optical signal from the front facet of the laser and to transmit the first optical signal to an optical fiber and to reflect a component of the first optical signal back to the laser;
a back facet monitor (BFM) to receive a second optical signal and the reflected component from the rear facet of the laser; and
a feedback circuit to monitor the quantity of reflected component.

2. The optical assembly of claim 1 wherein the feedback circuit compares a quantity of light received at the BFM to a quantity of current received at the laser.

3. The optical assembly of claim 2 further comprising a thermoelectric cooler (TEC) thermally coupled to the laser.

4. The optical assembly of claim 3 wherein the TEC receives an output signal from the feedback circuit to adjust the temperature of the laser based upon a measured ratio of the quantity of light received at the BFM to the quantity of current received at the laser.

5. The optical assembly of claim 4 wherein adjusting the temperature of the laser controls the optical wavelength emitted by the laser.

6. The optical assembly of claim 2 wherein the laser is a distributed feedback laser.

7. The optical assembly of claim 2 wherein the current received at the laser is a non-return to zero (NRZ) format signal.

8. The optical assembly of claim 2 wherein the BFM is a diode.

9. The optical assembly of claim 3 wherein the TEC is an analog comparator.

10. The optical assembly of claim 3 wherein the TEC is a flash memory having a lookup table.

11. A method comprising:
transmitting an optical signal from a laser to a thin film filter (TFF);
monitoring an internally reflected signal that does not pass through the TFF; and
aligning an emission wavelength of the laser based on the internally reflected signal monitored from the TFF.

12. The method of claim 11 wherein monitoring the internally reflected signal comprises receiving the internally reflected signal at a feedback circuit as a component of a back facet signal from the laser.

13. The method of claim 12 further comprising the feedback circuit comparing the back facet signal with a quantity of current received at the laser.

14. The method of claim 13 further comprising the feedback circuit transmitting a signal to a thermoelectric cooler (TEC) to adjust the temperature of the laser.

15. A system comprising:
an integrated circuit including:
a laser having a front facet and a rear facet;
a thin film filter (TFF) to receive a first optical signal from the front facet of the laser and to reflect a component of the first optical signal back to the laser;
a back facet monitor (BFM) to receive a second optical signal and the reflected component from the rear facet of the laser; and
a feedback circuit to monitor the quantity of reflected component; and
an optical fiber to receive the first optical signal from the TFF.

16. The system of claim 15 further comprising a second IC having a receiver to receive the first optical signal from the optical fiber.

17. The system of claim 16 wherein the first IC is a central processing unit (CPU) and the second IC a chipset.

18. The system of claim 15 wherein the feedback circuit compares a quantity of light received at the BFM to a quantity of current received at the laser.

19. The system of claim 18 further comprising a thermo-electric cooler (TEC) thermally coupled to the laser.

20. The system of claim 19 wherein the TEC receives an output signal from the feedback circuit to adjust the temperature of the laser based upon a measured ratio of the quantity of light received at the BFM to the quantity of current received at the laser.
